(19) United States
(12) Patent Application Publication
(10) Pub. No.: US 2012/0137053 A1
(43) Pub. Date: May 31, 2012

(54) MICROPROCESSOR

(75) Inventors: Yoshihide MAJIMA, Tokyo (JP); Makio ABE, Tokyo (JP)

(73) Assignee: MITSUMI ELECTRIC CO., LTD., Tokyo (JP)

(21) Appl. No.: 13/300,748

(22) Filed: Nov. 21, 2011

(30) Foreign Application Priority Data
Nov. 29, 2010 (JP) 2010-265642

(51) Int. Cl. G06F 12/02; G06F 13/24

(52) U.S. Cl. 711/103; 710/269; 711/E12.008

(57) ABSTRACT

A microprocessor to be connected with an external device is disclosed. The microprocessor includes a non-rewritable memory including a first interrupt vector table storing addresses of plural programs that allow plural types of interrupts, and an area storing a processing program in an address indicated by each of vectors in the first interrupt vector table; a rewritable non-volatile memory including a second interrupt vector table that includes contents identical to contents of the first interrupt vector table; an address changing section that conducts address change from an address for accessing the first interrupt vector table to another address for accessing the second interrupt vector table; a writing section that writes an address of an arbitrary vector of the second interrupt vector table and a processing program stored in the address indicated by the arbitrary vector in the rewritable non-volatile memory upon instruction supplied from the external device.

### CROSS-REFERENCE TO RELATED APPLICATION

The present application is based upon and claims the benefit of priority of Japanese Patent Application No. 2010-265642, filed on Nov. 29, 2010, the entire contents of which are incorporated herein by reference.

### BACKGROUND OF THE INVENTION

1. Field of the Invention

The present invention relates to a microprocessor that has a first memory that is non-rewritable and a second memory that is rewritable nonvolatile.

2. Description of the Related Art

Interrupt in a microprocessor includes hardware interrupt and software interrupt, and which interrupt is carried out can be known by an interrupt vector. A process executed by a causing factor of interrupt is determined depending on a system of the microprocessor.

A correspondence table storing a header address of a program that is executed when interrupt is caused is called an interrupt vector table, and a processing program is executed corresponding to the interrupt depending on the content of the interrupt vector table.

As shown in Section (A) of FIG. 1, a conventional microprocessor has either a non-rewritable mask ROM or a flash ROM that is a rewritable non-volatile memory, as a program memory. In addition, a conventional microprocessor may have a mask ROM and a flash ROM as a program memory, as shown in Section (B) of FIG. 1. In both illustrated examples in FIG. 1, the interrupt vector table is mapped in a header area of such memories.

Incidentally, there has been proposed a microprocessor that includes a ROM that stores an interrupt vector that determines firmware that rewrites a flash memory and a control program that controls operations of a clocked serial interface (CSI) , and another ROM that stores another interrupt vector that determines at least the control program and another control program that controls operations of a communication section (see Japanese Patent Application Laid-Open Publication No. 2001-43206, for example). In such a microprocessor, priority level of an interrupt request signal sent from plural incorporated peripheral circuits is controlled and sent to a CPU at the time of a normal operation mode, and an interrupt request signal input from CSI in response to a rewritable mode signal synchronous with a rewritable mode setting is determined as the topmost priority and sent to the CPU at the time of a rewritable mode.

### SUMMARY OF THE INVENTION

When a mask ROM is used as a program memory, there is a problem in that a great amount of time and high costs are required in collecting and remaking the mask ROM when there is an error in a program in the mask ROM, because the program cannot be corrected after the mask ROM is shipped.

When a flash ROM is used as a program memory, stored data may be deleted when abnormal circumstances such as power problem are raised at the time of writing, or when a malfunction of the program takes place. Namely, there may be a problem in that if a flash ROM writing program (update program) is deleted, the flash ROM cannot be updated anymore.

Even when the mask ROM and the flash ROM are provided as the program memory, the interrupt vector table is stored in an area of the mask ROM. In this case, a significant limitation arises in creating a program to be stored in the flash ROM. In addition, appropriate measures against the trouble found in the program of the mask ROM cannot be taken.

The present invention has been made in view of the above, and provides a microprocessor where an interrupt processing program stored in a rewritable memory can be modified.

An aspect of the present invention provides a microprocessor to be connected with an external device, the microprocessor including a non-rewritable memory including a first interrupt vector table that stores addresses of plural programs that allow plural types of interrupts, and an area that stores a processing program in an address indicated by each of vectors in the first interrupt vector table; a rewritable non-volatile memory including a second interrupt vector table that includes contents identical to contents of the first interrupt vector table; an address changing section that conducts address change from an address for accessing the first interrupt vector table to another address for accessing the second interrupt vector table; a writing section that writes an address of an arbitrary vector of the second interrupt vector table and a processing program stored in the address indicated by the arbitrary vector in the rewritable non-volatile memory upon instruction supplied from the external device.

### BRIEF DESCRIPTION OF THE DRAWINGS

FIG. 1 illustrates examples of memory address allocation in a related art microprocessor.

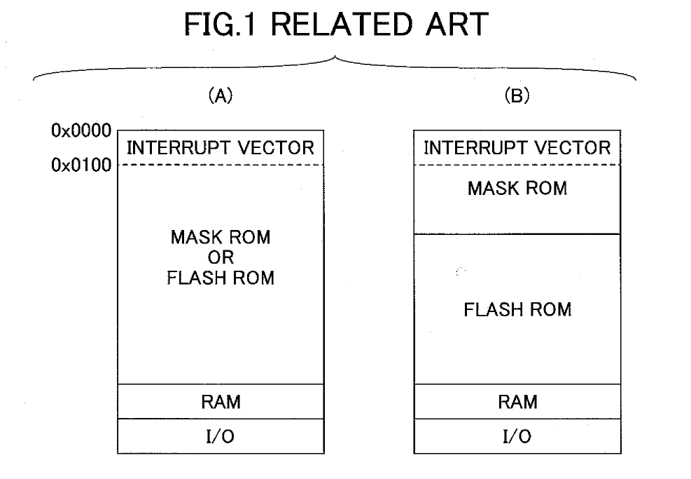

FIG. 2 is a block diagram of a microprocessor according to an embodiment of the present invention.

FIG. 3 illustrates an example of memory address allocation in the microprocessor according to the embodiment of the present invention.

FIG. 4 is a block diagram of an interrupt vector switching circuit in the microprocessor according to the embodiment of the present invention.

FIG. 5 illustrates address allocation in a mask ROM and a flash ROM in the microprocessor according to the embodiment of the present invention.

FIG. 6 illustrates address allocation in a mask ROM and a flash ROM in a general microprocessor, for comparison purposes.

FIG. 7 is a flowchart of a process executed by a CPU in the microprocessor according to the embodiment of the present invention.

### DETAILED DESCRIPTION OF THE PREFERRED EMBODIMENTS

According to an embodiment of the present invention, there is provided a microprocessor where an interrupt processing program stored in a rewritable memory can be modified.

Hereafter, embodiments according to the present invention are explained with reference to the accompanying drawing.

<Microprocessor>

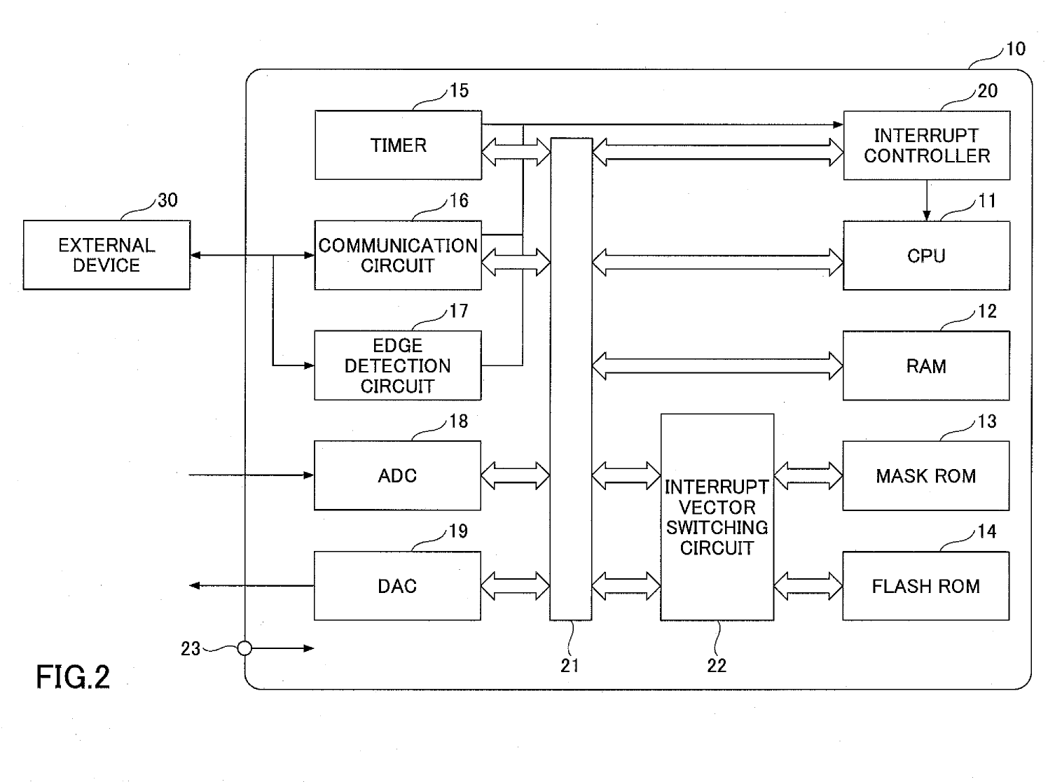

FIG. 2 shows a block diagram of a microprocessor according to an embodiment of the present invention. As shown, a microprocessor 10 includes a central processing unit (CPU) 11, a random access memory (RAM) 12, a mask read-only memory (ROM) 13, a flash ROM 14, a timer 15, and a communication circuit 16. In addition, the microprocessor 10 further includes an edge detection circuit 17, an analog to digital (AD) converter 18, a digital to analog (DA) converter 19, an interrupt controller 20 and the like. These sections (or circuits) except the edge detection circuit 17 are mutually connected through an inter bus 21.

Moreover, an interrupt vector switching circuit 22 is provided between the internal bus 21 and the mask ROM 13 and between the internal bus 21 and the flash ROM 14. Incidentally, the mask ROM 13 is a non-rewritable memory, and the flash ROM 14 is a rewritable nonvolatile memory. In addition, the internal bus 21 has an address bus, a data bus, and a control bus. Furthermore, the microprocessor 10 is provided with a reset terminal 23.

The CPU 11 executes a processing program stored in the mask ROM 13 and the flash ROM 14. At this time, the RAM 12 is used as a working area. The timer 15 counts clocks, generates a predetermined timing signal, and supplies, for example, a part of the timing signal to the interrupt controller 20 as an interrupt signal.

For example, the communication circuit 16 communicates to and from an external device 30 such as a higher-level device or a personal computer. The edge detection circuit 17 detects an edge of the communication signal exchanged between the external device 30 and the communication circuit 16, and supplies an edge detection signal to the interrupt controller 20 as an interrupt signal.

The AD converter 18 digitizes an analog signal supplied from a predetermined external circuit thereby to generate a digital signal and supplies the digital signal to the CPU 11 through the internal bus 21. The DA converter 19 converts a digital signal supplied from the CPU 11 thereby to generate an analog signal and supplies the analog signal to an external circuit. The interrupt controller 20 conducts priority level control with respect to the interrupt signal supplied from the timer 15, the edge detection circuit 17, and the like.

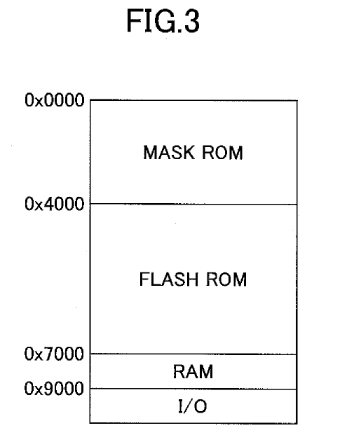

FIG. 3 illustrates an example of memory address allocation in the microprocessor 10 according to this embodiment. The microprocessor 10 communicates with the external device 30 always or when necessary. The microprocessor 10 manages a memory arrangement in the mask ROM 13 in accordance with a specification of the CPU 11, in order to create an environment where the CPU 11 can execute a program stored in the mask ROM 13 after the microprocessor 10 is turned on.

To this end, the mask ROM 13, the flash ROM 14, the RAM 12, and built-in input/output (I/O) devices of the timer 15 through the interrupt controller 20 or the like are arranged in this order in the memory, as shown in FIG. 3.

<Interrupt Vector Switching Circuit>

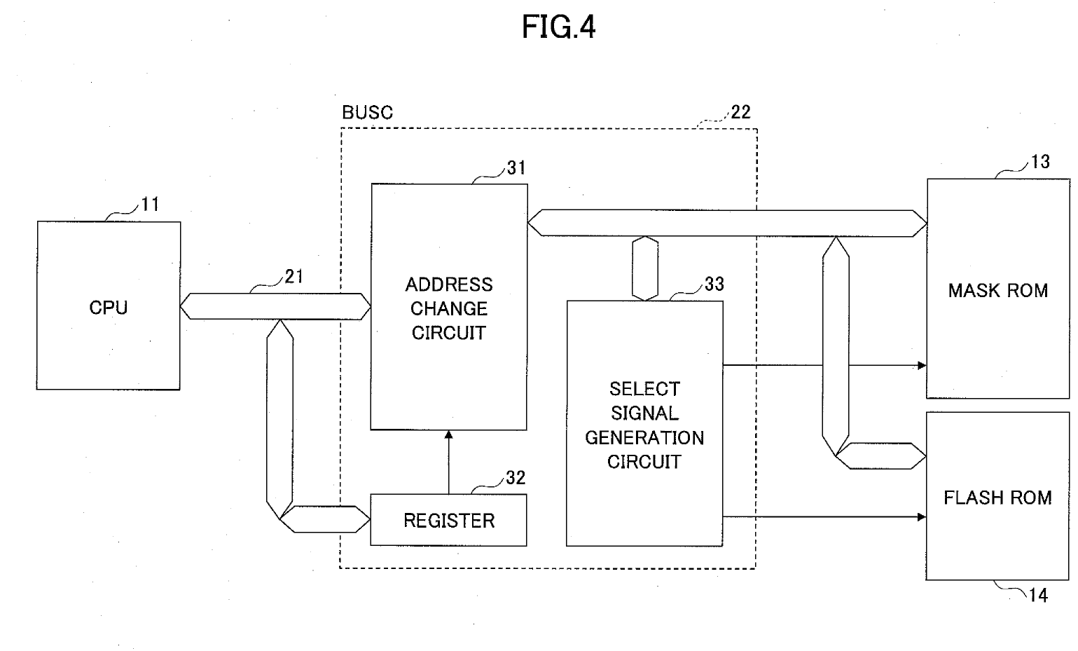

FIG. 4 is a block diagram of the interrupt vector switching circuit 22 in the microprocessor 10 according to this embodiment. The microprocessor 10 according to this embodiment is provided with the interrupt vector switching circuit 22 that allows the CPU 11 to refer selectively to an interrupt vector table in the mask RCM 13 or to an interrupt vector table in the flash ROM 14.

Referring to FIG. 4, the interrupt vector switching circuit 22 includes a register 32, an address change circuit 31, and a selection signal generation circuit 33. The register 32 retains a value 0 or 1 that is set by and sent from the CPU 11. For example, when the interrupt vector table of the mask ROM 13 is referred to by the CPU 11, a value 0 is set, and when the interrupt vector table of the flash ROM 14 is referred to by the CPU 11, a value 1 is set.

The value of the register 32 is supplied to the address change circuit 31, and an address is supplied to the address change circuit 31 through the internal bus 21. When a value 0 is supplied from the register 32, the address change circuit 31 stops the address changing process and outputs the address supplied from the CPU 11 as it is.

On the other hand, when a value 1 is supplied from the register 32, the address change circuit 31 conducts the address changing process, specifically changes the first 8 bits supplied from the CPU 11 to, for example, 0×40 (0× is indicates as the form of hexadecimal display), and outputs the changed address. The output address of the address change circuit 31 is supplied to the selection signal generation circuit 33, the mask ROM 13, and the flash ROM 14.

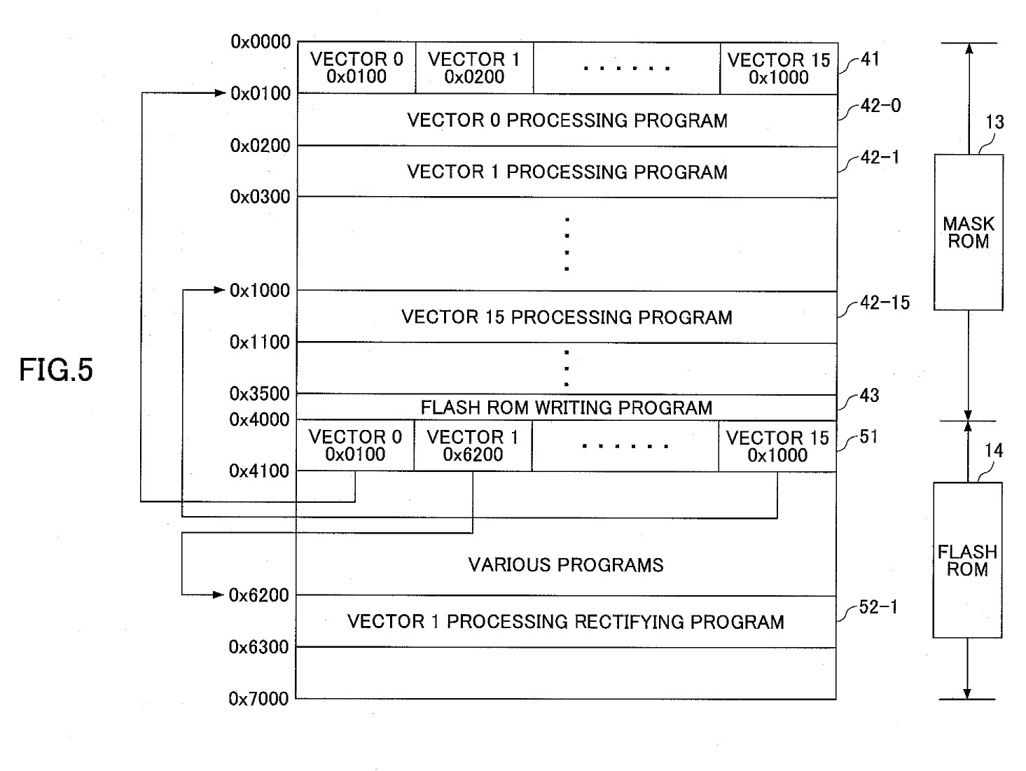

The change of the first 8 bits is conducted in order to change an address of an interrupt vector table 41 (FIG. 5) of the mask ROM 13 to an address of an interrupt vector table 51 (FIG. 5) of the flash ROM 14. The number of conversion bits and the changed value may be variously different depending on an addressing architecture in a system of the microprocessor.

The selection signal generation circuit 33 determines which interrupt vector table, namely the interrupt vector table 41 of the mask ROM 13 or the interrupt vector table 51 of the flash ROM 14, should be referred to, by referring to the first 4 bits of the output address of the address change circuit 31. When it is determined that the interrupt vector table 41 of the mask ROM 13 should be referred to, the selection signal generation circuit 33 generates a selection signal that indicates the interrupt vector table 41 is referred to (the flash ROM 14 is not elected). When it is determined that the interrupt vector table 51 of the flash ROM 14 should be referred to, the selection signal generation circuit 33 generates a selection signal that indicates the interrupt vector table 51 is referred to (the mask ROM 13 is not elected). The generated selection signal is supplied to the flash ROM 14.

FIG. 3 illustrates address allocation in the mask ROM 13 and the flash ROM 14 in this embodiment. As illustrated, addresses 0×0000 through 0×3FFF are allocated to the mask ROM 13, and addresses 0×4000 through 0×6FFF are allocated to the flash ROM 14.

Specifically, the interrupt vector table 41 is arranged in addresses 0×0000 through 0×00FF, which are header areas of the mask ROM 13. In the illustrated example, interrupt vectors 0 through 15 are allocated in the interrupt vector table 41. For example, a value of an interrupt vector 0 is set to an address 0×0100, which is a header address of a processing program of the interrupt vector 0; a value of an interrupt vector 1 is set to an address 0×200, which is a header address of a processing program of the interrupt vector 1; a value of an interrupt vector 15 is set to an address 0×1000, which is a header address of the processing program of the interrupt vector 15. Incidentally, the “interrupt vector” is simplified just as the “vector” in the accompanying drawings, as may be necessary.

Here, as occurrence factors of the interrupt, there are hardware interrupts, such as power supply turning-on, conversion completion in the AD converter 18, lapse of predetermined time measured by the timer 15, completion of a transmission/reception by the communication circuit 16, a reset signal input from the reset terminal 23, and the like, and various software interrupts.

A processing program 42-0 of the interrupt vector 0 is stored in addresses 0×0100 through 0×01FF of the mask ROM 13; a processing program 42-1 of the interrupt vector 1 is stored in addresses 0×0200 through 0×02FF; a processing program 42-15 of the interrupt vector 15 is stored in addresses 0×1000 through 0×10FF.

Various programs and data are stored in addresses 0×1100 or later of the mask ROM 13. In addition, a flash ROM writing program 43 is stored in the mask ROM 13, specifically the last addresses 0×3500 through 0×3FFF of the mask ROM 13. The flash ROM writing program 43 writes, deletes, and verifies data in the flash ROM 14. With this, an address of an arbitrary vector of the second interrupt vector table 51 and a processing program corresponding to the address of the arbitrary vector can be written in the flash ROM 14 upon instruction supplied from the external device 30.

In addition, the interrupt vector table 51 is arranged in address areas 0×4000 through 0×40FF, which are header areas of the flash ROM 14. At the time of manufacturing, the same interrupt vector table as that of the mask ROM 13 is written into the flash ROM 14, and thus the flash ROM 14 initially stores the same interrupt vector table as that of the mask ROM 13.

Interrupt vectors 0 through 15 are arranged in the interrupt vector table 51 of the flash ROM 14. Specifically, a value of the interrupt vector 0 is set to a header address 0×0100 of the processing program of the interrupt vector 0; a value of the interrupt vector 1 is set to an address 0×0200; and a value of the interrupt vector 15 is set to an address 0×1000.

Various programs and data are stored in addresses 0×4100 through 0×61FF of the flash ROM 14, and addresses 0×6200 or later of the flash ROM 14 are not used at an initial stage. Incidentally, a value of the interrupt vector 1 is set to the address 0×6200 of the flash ROM 14 in FIG. 5, because the value is updated. At an initial stage, a value of the interrupt vector 1 is set to the address 0×0200 of the flash ROM 14.

Incidentally, because of greater data capacity per unit area, if the mask ROM 13 is larger than the flash ROM 14, various programs including the processing programs of the interrupt vectors 0 through 15 are stored in the mask ROM 13.

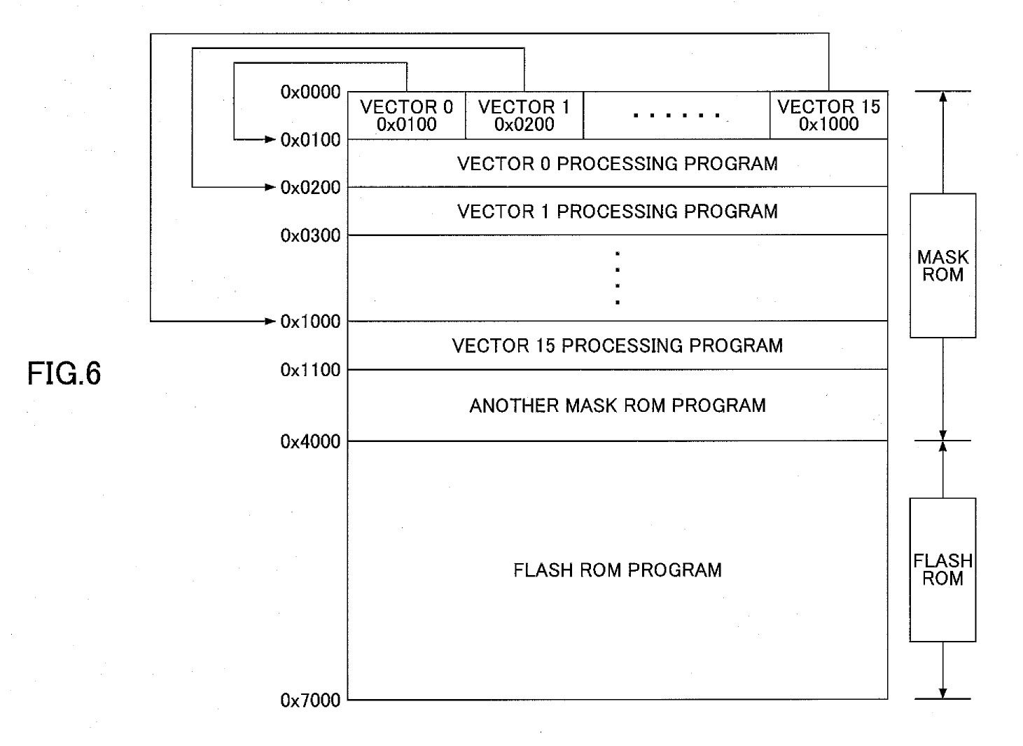

For comparison purposes, general address allocation of a mask ROM and a flash ROM according to a comparison example is illustrated in FIG. 6. As shown, the interrupt vector table is arranged in addresses 0×0000 through 0×00FF, which are header areas of the mask ROM.

The interrupt vectors 0 through 15 are arranged in the interrupt vector table of the mask ROM. For example, a value of the interrupt vector 0 is set to the address 0×0100, which is a header address of a processing program of the interrupt vector 0; a value of the interrupt vector 1 is set to the address 0×200, which is a header address of a processing program of the interrupt vector 1; a value of the interrupt vector 15 is set to the address 0×1000, which is a header address of the processing program of the interrupt vector 15.

In the mask ROM, the processing program of the interrupt vector 0 is stored in the addresses 0×0100 through 0×01FF; the processing program of interrupt vector 1 is stored in the addresses 0×0200 through 0×02FF; and the processing program of the interrupt vector 15 is stored in the addresses 0×1000 through 0×10FF. In addition, various programs are stored in the addresses 0×1100 or later of the mask ROM.

On the other hand, no interrupt vector table is arranged in the flash ROM. In addition, various programs are stored in the addresses 0×4000 through 0×6FFF of the flash ROM.

<Flowchart of Reset Processing>

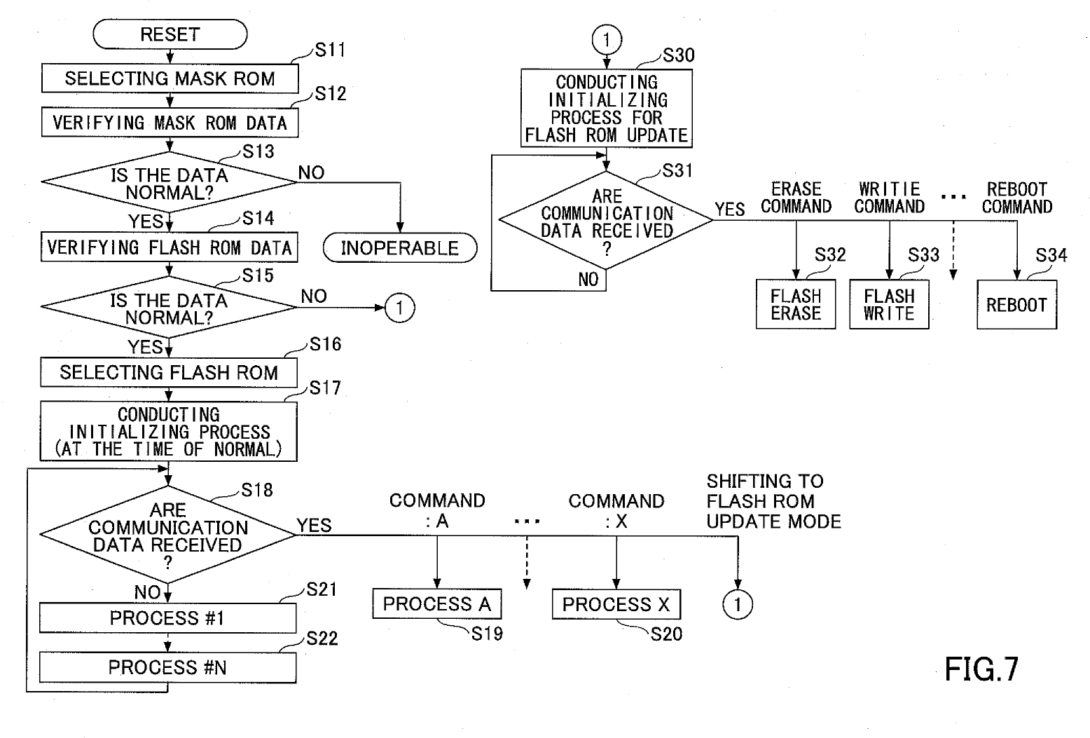

FIG. 7 is a flowchart of a process executed by the CPU 11, according to the embodiment of the present invention. This process is started to be executed by the CPU 11 under control of the controller 20, when a reset signal is generated by a circuit (not shown) at the time of switching on the microprocessor 10, or when a low level reset signal is supplied to the reset terminal 23.

Referring to FIG. 7, the CPU 11 sets a value 0 to the register 32 at Step S11, and selects the interrupt vector table of the mask ROM 13. Next, data verification is conducted with respect to the entire area of the mask ROM 13 at Step S12. Here, for example, checksums of all data read from the entire area of the mask ROM 13 are calculated, and the read-out checksums are compared with checksum values written in advance in a particular area of the mask ROM 13.

Then, when the checksums of the entire data read out from the entire area of the mask ROM 13 are in agreement with the checksum values in the particular area at Step S13, the mask ROM 13 is determined to be normal. Otherwise, the mask ROM 13 is determined to be abnormal and inoperable, and thus the process is terminated.

When the mask ROM 13 is normal, data verification is conducted with respect to the flash ROM 14 at Step S14. Here, for example, checksums of all data read from the entire area of the flash ROM 14 are calculated, and the read-out checksums are compared with checksum values written in advance in a particular area of the flash ROM 14. Then, when the checksums of the entire data read out from the entire area of the flash ROM 14 are in agreement with the checksum values in the particular area at Step S15, the flash ROM 14 is determined to be normal. Otherwise, the flash ROM 14 is determined to be abnormal.

When the flash ROM 14 is abnormal, the process proceeds to Step S30. When the flash ROM 14 is normal, the CPU 11 sets a value 1 in the register 32 at Step S16, and selects the interrupt vector table of the flash ROM 14. Next, initialization process is conducted at the time of normal operation, at Step S17, and then process at the time of normal operation is executed.

Namely, it is determined at Step S18 whether communication data are received from the external device 30. When received, a process prescribed in the communication data is executed. For example, when the communication data are command A, a processing A corresponding to the command A is executed at Step S19; when the communication data are command X, a processing X corresponding to the command X is executed at Step S20; and when the communication data are shift command to flash ROM update mode, the process proceeds to Step S30.

When the communication data are not received at Step S18, processes #1 through #n at the time of normal are executed at corresponding Steps S21 through S22, and the process proceeds to Step S18.

On the other hand, the CPU 11 executes an initialization process of flash ROM update at Step S30. Specifically, the communication circuit 16 is initialized. In addition, a value 0 is set in the register 32, and the interrupt vector table of the mask ROM 13 is selected. Subsequently, the flash ROM update process is executed.

Namely, it is determined at Step S31 whether communication data are received from the external device 30. When received, a process prescribed in the communication data is executed. For example, when the communication data are an erase command, an erase process is executed with respect to an area designated by a command of the flash ROM 14 at Step S32; and when the communication data are a write command, a write process is executed with respect to an area designated by a command of the flash ROM 14 at Step S33.

In addition, when the flash ROM update is completed, the external device 30 sends a reboot command. Therefore, when the communication data are the reboot command, the CPU 11 reboots the microprocessor 10 at Step S34. With this, the process illustrated in FIG. 7 is executed from Step S11. Incidentally, each of Steps S30 through S34 is a software interruption executed using the interrupt vector table 41 of the mask ROM 13.

Incidentally, while the verification process is executed using the checksums at Steps S12 and S14 in this embodiment, other verification methods using, for example, cyclic redundancy code (CRC) or parity may be employed in other embodiments.

Referring again to FIG. 5, even when a problem is found in a processing program 42-1 stored in the addresses 0×0200 through 0×02FF that correspond to the interrupt vector 1 of the interrupt vector table 41 of the mask ROM 13, the processing program 42-1 cannot be corrected because the addresses 0×0200 through 0×02FF exist in the mask ROM 13. In this case, the shift command to the flash ROM update mode is sent from the external device 30 to the microprocessor 10.

Then, Steps S30 through S34 are executed by the CPU 11, and thus the value of the interrupt vector 1 in the interrupt vector table 51 of the flash ROM 14 is changed to, for example, 0×6200, as shown in FIG. 5.

In addition, a processing program 52-1 obtained by correcting the processing program 42-1 of the interrupt vector 1 is written in, for example, addresses 0×6200 through 0×62FF. Moreover, all the data are read out from the entire area of the flash ROM 14, and the checksum values are calculated. Then, the calculated checksum values are written in the particular area of the flash ROM 14.

Subsequently, when the processing A, X, and the processing #1-#n are conducted at Steps S18 through S22, or when the processing programs of the corresponding interrupt vectors 0 through 15 are executed, the interrupt vector table 51 of the flash ROM 14 is referred to. Therefore, the corrected processing program 52-1 is executed, when needed.

Similarly, programs stored in the mask ROM 13, other than interrupt processing programs, can be normally executed, even if there is a problem in the programs, by referring to the interrupt vector table 51 of the flash ROM 14, when the program is corrected and the corrected program is stored in the flash ROM 14.

In addition to correction of programs, this embodiment according to the present invention is applicable when programs need to be modified in order to improve functions or add new functions. Therefore, functional improvement of the microprocessor 10 according to embodiments of the present invention can be realized thereby to enhance the product value, even after the microprocessor 10 is shipped.

In addition, the flash ROM writing program 43 is not destroyed by an external factor such as static electricity, because the flash ROM writing program 43 is also stored in the mask ROM 13. Therefore, even if a problem may be caused in the programs and data stored in the flash ROM 14 by, for example, an external factor such as static electricity, because Steps S15 through S30 (FIG. 7) are conducted by the CPU 11, the flash ROM writing program 43 stored in the mask ROM 13, which is not destroyed, can be booted, so that data in the flash ROM 14 can be rewritten through the external device 30, thereby to restore the flash ROM 14.

In addition, because the interrupt vector table 41 and the interrupt vector table 51 are arranged in the mask ROM 13 and the flash ROM 14, respectively, completely different interrupt processing can be conducted with respect to the programs stored in the mask ROM 13 and the programs stored in the flash ROM 14.

While the present invention has been described in reference to the foregoing embodiments, the present invention is not limited to the disclosed embodiments, but may be modified or altered within the scope of the accompanying claims.

What is claimed is:

1. A microprocessor to be connected with an external device, the microprocessor comprising:
a non-rewritable memory including
a first interrupt vector table that stores addresses of plural programs that allow plural types of interrupts, and
an area that stores a processing program in an address indicated by each of vectors in the first interrupt vector table;
a rewritable non-volatile memory including a second interrupt vector table that includes contents identical to contents of the first interrupt vector table;
an address changing section that conducts address change from an address for accessing the first interrupt vector table to another address for accessing the second interrupt vector table; and
a writing section that writes an address of an arbitrary vector of the second interrupt vector table and a processing program stored in the address indicated by the arbitrary vector in the rewritable non-volatile memory upon instruction supplied from the external device.

2. The microprocessor claimed in claim 1, wherein the non-rewritable memory further stores another processing program that executes instructions supplied from the external device, and
wherein address change conducted by the address changing section is halted when writing to the rewritable non-volatile memory upon instruction supplied from the external device is conducted.

3. The microprocessor claimed in claim 2, wherein the non-rewritable memory stores verification data that are to be used to verify data stored in the non-rewritable memory.

4. The microprocessor claimed in claim 2, wherein the rewritable non-volatile memory stores verification data to be used to verify data stored in the rewritable non-volatile memory.

5. The microprocessor claimed in claim 3, wherein the rewritable non-volatile memory stores verification data to be used to verify data stored in the rewritable non-volatile memory.
